(19) United States
(12) Patent Application Publication
(10) Pub. No.: US 2020/0154223 A1
(43) Pub. Date: May 14, 2020

(54) SYSTEMS AND METHODS FOR CALIBRATING MICROPHONE ASSEMBLIES INCLUDING A MEMBRANE BARRIER

(71) Applicant: KNOWLES ELECTRONICS, LLC, Itasca, IL (US)

(72) Inventors: Yu Du, Itasca, IL (US); Peifeng Mai, Itasca, IL (US)

(73) Assignee: KNOWLES ELECTRONICS, LLC, Itasca, IL (US)

(21) Appl. No.: 16/677,390

(22) Filed: Nov. 7, 2019

Related U.S. Application Data
(60) Provisional application No. 62/757,998, filed on Nov. 9, 2018.

(51) Int. Cl. H04R 29/00; H04R 19/04; H04R 1/04

(52) U.S. Cl. CPC H04R 29/004; H04R 2201/003; H04R 1/04; H04R 19/04

(57) ABSTRACT

A method comprises driving a microelectromechanical systems (MEMS) transducer of a microphone assembly using a test electrostatic signal. The microphone assembly comprises a substrate, a cover, a port providing an acoustic path from the MEMS transducer to an external atmosphere, and a non-porous elastomeric membrane disposed across the port and structured to seal the microphone assembly. A test electrostatic response of the MEMS transducer is measured, and a difference between the test electrostatic response and a calibration electrostatic response for a corresponding boundary condition of the membrane is determined. A calibration parameter is determined using stored calibration data based on the difference. The calibration data correlates calibration electrostatic responses with calibration acoustic responses of the MEMS transducer across a range of boundary conditions of the membrane. An acoustic response of the MEMS transducer is adjusted using the calibration parameter.

### CROSS-REFERENCE TO RELATED APPLICATIONS

The present application claims priority to and benefit of U.S. Provisional Application No. 62/757,998, filed Nov. 9, 2018, the entire disclosure of which is hereby incorporated by reference herein.

### TECHNICAL FIELD

The present disclosure relates generally to acoustic devices and more particularly to microphone assemblies having reduced contaminant susceptibility without significant reduction in audio performance, and methods therefor.

### BACKGROUND

Advancements in fabrication technologies have led to the development of progressively smaller acoustic devices including a motor disposed in a housing having one or more sound ports defining an acoustic passage between an interior of the housing and an exterior thereof. Such devices include microelectromechanical systems (MEMS) transducers and electret microphone assemblies that convert acoustic energy to electrical signals. These and other acoustic devices are typically integrated with a host device, like a cell phone, slate, laptop computer, earphone, hearing device among a variety of the other devices, machines, vehicles and appliances as is known generally. However these and other acoustic devices are susceptible to contamination from particulates, liquids and possibly light. Depending on the type of acoustic device and the use case, such contaminants may cause obstruction, interference, and corrosion among other adverse effects that compromise performance or reduce longevity.

### SUMMARY

In some embodiments, a method comprises driving a microelectromechanical systems (MEMS) transducer of a microphone assembly using a test electrostatic signal, the microphone assembly comprises: a substrate and a cover, a port providing an acoustic path from the MEMS transducer to an external atmosphere, and a non-porous elastomeric membrane disposed across the port and structured to seal the microphone assembly; measuring a test electrostatic response of the MEMS transducer; determining a difference between the test electrostatic response and a calibration electrostatic response for a corresponding boundary condition of the membrane; determining a calibration parameter using stored calibration data based on the difference, the calibration data correlating calibration electrostatic responses with calibration acoustic responses of the MEMS transducer across a range of boundary conditions of the membrane; and adjusting an acoustic response of the MEMS transducer using the calibration parameter.

In some embodiments, a microphone assembly comprises a substrate; a cover; a microelectromechanical systems (MEMS) transducer disposed within an internal volume of the microphone assembly defined between the substrate and the cover, the MEMS transducer configured to generate an electrical signal responsive to an acoustic signal; a port providing an acoustic path from the MEMS transducer to an external atmosphere; a non-porous elastomeric membrane disposed across the port and structured to seal the microphone assembly; and an integrated circuit disposed within the internal volume and electrically coupled to an electrical output of the transducer. The integrated circuit is configured to: drive the MEMS transducer using a test electrostatic signal; measure a test electrostatic response of the MEMS transducer; determine a difference between the test electrostatic response and a calibration electrostatic response for a corresponding boundary condition of the membrane; determine a calibration parameter using stored calibration data based on the difference, the calibration data correlating calibration electrostatic responses with calibration acoustic responses of the MEMS transducer across a range of boundary conditions of the membrane; and adjust an acoustic response of the MEMS transducer using the calibration parameter.

In some embodiments, a microphone assembly comprises a substrate; a cover; a microelectromechanical systems (MEMS) transducer disposed within an internal volume of the microphone assembly defined between the substrate and the cover, the MEMS transducer configured to generate an electrical signal responsive to an acoustic signal; a port providing an acoustic path from the MEMS transducer to an external atmosphere; a non-porous elastomeric membrane disposed across the port and structured to seal the microphone assembly; and an integrated circuit disposed within the internal volume, the integrated circuit electrically coupled to an electrical output of the transducer and configured to be electrically coupled to a host device controller. The integrated circuit is configured to: drive the MEMS transducer using a test electrostatic signal received from the host device controller; transmit a test electrostatic response signal received from the MEMS transducer to the host device controller, the test electrostatic response signal corresponding to a test electrostatic response of the acoustic transducer; retrieve stored calibration data from a memory of the microphone assembly and communicate the stored calibration data to the host device controller so as to allow the host device controller to determine a calibration parameter therefrom; and communicate an acoustic response signal corresponding to an acoustic response of the MEMS transducer to the host controller device, the host device controller configured to adjust the acoustic response of the MEMS transducer using the calibration parameter.

### BRIEF DESCRIPTION OF DRAWINGS

The objects, features and advantages of the present disclosure will become more fully apparent to those of ordinary skill in the art upon consideration of the following Detailed Description and the appended claims in conjunction with the accompanying drawings.

FIG. 1 is a schematic side cross-section view of a microphone assembly, according to an embodiment.

FIG. 2A is schematic block diagram of an integrated circuit first portion, and FIG. 2B is a schematic block diagram of an integrated circuit second portion of an integrated circuit that may be used in the microphone assembly of FIG. 1, according to an embodiment.

FIG. 2C is a schematic block diagram of an integrated circuit that may be used in the microphone assembly of FIG. 1, and a host device controller coupled to the integrated circuit, according to an embodiment.

FIG. 3A shows plots of a calibration electrostatic response of a MEMS transducer in response to a calibration electrostatic signal for various compliances of a non-porous elastomeric membrane that is disposed across a port of an microphone assembly that includes the MEMS transducer.

FIG. 3B shows plots of a calibration acoustic response of the MEMS transducer of FIG. 3A in response to a calibration acoustic signal for various compliances of the non-porous elastomeric membrane.

FIG. 4 is a schematic flow diagram of a method for calibrating a microphone assembly that includes a non-porous elastomeric membrane disposed across a port of the microphone assembly, according to an embodiment.

In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure described herein and illustrated in the figures can be arranged, substituted, combined, and designed in a variety of different configurations, all of which are contemplated and made part of this disclosure.

### DETAILED DESCRIPTION

The disclosure relates generally to calibration of an acoustic device having an elastomeric membrane that prevents or at least reduces ingress of contaminants without significantly obstructing the passage of sound through an acoustic passage defined partly by a sound port of the acoustic device to account for variations in boundary conditions of the acoustic transducer (e.g., variations in compliance of the membrane, and in some embodiments, variations in compliance of a diaphragm of a MEMS transducer and/or a volume of a housing of the acoustic device).

Various embodiments of the systems and methods described herein provide benefits including, for example, one or more of the following: (1) allowing highly sensitive acoustic measurements irrespective of air pressure and/or temperature that the acoustic device is exposed to; (2) enabling use of ingress protection membranes with acoustic transducers without having to provide a pressure equalization vent therein which can lead to contaminant ingress; (3) enabling estimation of pressure difference in and out of microphone assemblies; and (4) providing in-situ calibration and compensation.

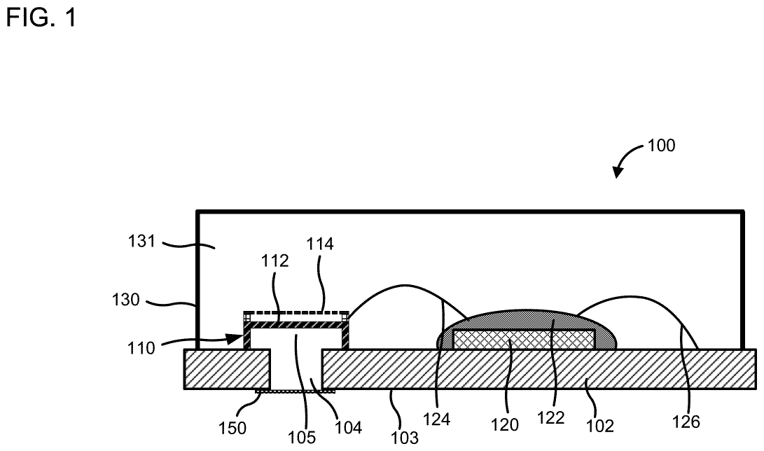

FIG. 1 is a sectional view of an acoustic device embodied as a microphone assembly 100, according to an embodiment. The microphone assembly 100 includes an acoustic transducer 110 (e.g., a MEMS transducer) configured to generate an electrical signal responsive to an acoustic signal, and an integrated circuit 120 (e.g., an application-specific integrated circuit, or ASIC) disposed within an internal volume of the microphone assembly 100 defined between a base 102 and a cover 130. The base 102 may be or include a printed circuit board (PCB) (e.g., FR4). In some embodiments, the base 102 may include an electromagnetic shielding material. The cover 130 is disposed over the base 102 and coupled thereto so as to define a volume therebetween. The cover 130 may be formed from metal (e.g., aluminum, copper, stainless steel, etc.), FR4, plastics, polymers, etc., and is coupled to the base 102, via an adhesive, fusion bonding, soldering or other fastening material.

A port 104 is formed in the base 102 and at least partially defines an acoustic path from the acoustic transducer 110 to the external atmosphere. In other embodiments, the port 104 may be formed in the cover 130.

In one embodiment, the acoustic transducer 110 is a microelectromechanical system (MEMS) transducer (e.g., a MEMS motor). In particular embodiments as shown in FIG. 1, the acoustic transducer 110 is a MEMS condenser transducer having a diaphragm 112 that moves relative to a back plate 114 in response to changes in air pressure due to acoustic signals impinging on the diaphragm 112 through the port 104. In these embodiments, the diaphragm 112 separates the internal volume into a front volume 105 and a back volume 131, wherein the front volume 105 is in fluidic communication with the acoustic path through the port 104. In other embodiments, the acoustic transducer 110 is a non-MEMS device embodied, for example, as an electret transducer having a diaphragm that moves relative to a back plate. In still other embodiments, the acoustic transducer 110 is a piezoelectric transducer or some other known or future electro-acoustic transduction device implemented using MEMS or other technology. In the illustrated embodiment, the back plate 114 is provided over the diaphragm 112. In other embodiments, the back plate 114 may be provided under the diaphragm 112. In various embodiments, the features of the present disclosure could be applied to transducers including more than one diaphragm and/or back plate.

The acoustic transducer 110 is mounted on the base 102 over the port 104. Alternatively, the acoustic transducer 110 could be mounted on the cover 130 over the port 104. In FIG. 1, the transducer cavity forms part of the front volume 105, in acoustic communication with the acoustic path formed partly by the port 104. Non-MEMS electret condenser transducers are similarly situated relative to the port of the microphone assembly. Other types of transducers however may not necessarily be mounted directly over or adjacent the port.

The microphone assembly 100 generally includes an external-device interface (i.e., an electrical interface) having a plurality of electrical contacts (e.g., power, ground data, clock) for electrical integration with a host device. The external device interface can be disposed on an outer surface of the base 102 and configured for reflow soldering to a host device. Alternatively the interface can be disposed on some other surface of the base 102 or the cover 130. In FIG. 1, the integrated circuit 120 is electrically coupled to an electrical output of the acoustic transducer 110 by one or more electrical leads 124. FIG. 1 also show the integrated circuit 120 covered by an encapsulating material 122, which may have electrical insulating, electromagnetic and thermal shielding properties. The integrated circuit 120 receives an electrical signal from the acoustic transducer 110 and may amplify or condition the signal before outputting a digital or analog acoustic signal. FIG. 1 shows one or more electrical leads 126 electrically coupling the integrated circuit 120 to an external-device interface. The integrated circuit 120 may also include a protocol interface circuit, like PDM, PCM, SoundWire, I2C, I2S or SPI, among others, with corresponding contacts on the external-device interface.

A non-porous elastomeric membrane 150 (also referred to herein as the “membrane”) is disposed across the acoustic path and is structured to seal the microphone assembly 100. The membrane 150 at least partially prevents contamination by solids, liquids or light via the port 104 while permitting the propagation of an acoustic signal along the acoustic path. As shown in FIG. 1, the membrane 150 is disposed on an outer surface 103 of the base 102. Alternative, the membrane 150 could be disposed on an inner surface of the base 102 within the internal volume of the microphone assembly 100. Alternatively, in embodiments in which a port is defined in the cover 130, the membrane 150 is disposed on an outer or inner surface of the cover 130 over the port. Various embodiments of non-porous elastomeric membranes, and acoustic transducer assemblies including such non-porous elastomeric membranes are described in U.S. Provisional Application No. 62/663,160, filed Apr. 26, 2018 and entitled “Acoustic Assembly Having an Acoustically Permeable Membrane,” the disclosure of which is hereby incorporated by reference herein in its entirety.

The membrane 150 may be coupled to the base 102, for example, by a covalent bond or an adhesive bond or other fastener. In other implementations in which the port 104 is defined in the cover 130, the membrane 150 is coupled to the cover 130. Generally, the membrane 150 is an acoustically transparent and non-porous material that is impermeable to contaminants while permitting propagation of an acoustic signal across the membrane 150 without significant attenuation. For example, a compliance of the membrane 150 may be an order of magnitude larger than a compliance of the diaphragm 112 at 1 atm atmospheric pressure and room temperature. The membrane 150 may be impermeable to liquids and solids including sprays, mists, aqueous solutions, colloids, some solvents and vapors, fine dust, smoke, soot, debris, and other particulates. The membrane 150 may also be impermeable to microbial contaminants. In other embodiments, the membrane 150 has an electromagnetic shielding property that prevents or at least reduces ingress of light as discussed herein.

In one embodiment, the non-porous elastomeric membrane 150 comprises a siloxane material. Siloxane materials include, for example, polysiloxanes such as polydimethylsiloxane (PDMS) among other polymers and elastomeric materials. Siloxane materials may have one or more of the following chemical structures: [—Si(CH₃)RO—]; [—Si(CH₃)XO—]; [—Si(C₆H₅)RO—]; [—Si(CH₃)₂(CH₂)ₘ—]; [Si(CH₃)₂(CH₂)ₘ—Si(CH₃)₂O—]; and [Si(CH₃)₂(C₆H₄)ₘSi(CH₃)₂O—], where R is typically an n-alkyl group and X is an n-propyl group made polar by substitution of atoms such as Cl or N. Siloxane materials include silicones, like VQM, PVQM, of which the siloxane functional group forms the so-call backbone. Such siloxane materials may also include additives including but not limited to SiO₂ filler, MQ-resin filler, transition metal oxide fillers (e.g., TiO₂) and calcite compounds as well as an adhesion promotor for hydrophilic surfaces.

In some embodiments, the membrane 150 is bonded to a surface of the base 102 using an adhesive between the membrane 150 and the surface (e.g., the outer surface 103) to which the membrane 150 is bonded (e.g., the outer surface 103 of the base 102). However, adhesives may increase cost or pose a contamination concern. In other embodiments, the membrane 150 is bonded to the base 102 without using an adhesive. Siloxanes form a strong covalent bond with some materials. Such covalent bonds include for example Si—O—Si bonds. Thus in some implementations, the membrane 150 is bonded covalently. A covalent bond may be formed by mating ionized surfaces of the membrane 150 and the base 102 or other portion of the microphone assembly 100 to which the membrane 150 will be bonded, mating the ionized parts, and applying heat to the mated parts. Surface ionization may be performed by exposing the mating surface (e.g., the outer surface 103) to plasma or other ionizing energy source. Suitable ionization sources may depend on the type of material to be ionized. Plasmas with lighter ions like oxygen or nitrogen are suitable for ionizing thin membranes without damage whereas heavier plasma ions like argon may be use on the surface to which the membrane will be bonded. During ionization, the —O—Si(CH₃)₂— group of a siloxane membrane is converted to silanol group (—OH), which facilitates covalent bonding.

In some embodiments, the base 102 and/or the cover 130 include a metal or other barrier that prevents ingress of electromagnetic radiation. Such radiation may be a source of noise and other performance degradation. However the port 104 remains unprotected. Thus, in some embodiments, the membrane 150 includes a radiation shielding property that prevents or at least reduces propagation of electromagnetic radiation into the internal volume of the microphone assembly 100 via the port 104. Such radiation typically includes light in the infrared, visible and ultraviolet frequency ranges, although it may not be necessary to filter all such frequencies in all embodiments. In one embodiment, the radiation shielding property can be attributed to a thin layer (e.g., of 1 nm to 100 nm) of electromagnetic shielding material (e.g., a light reflecting material, light absorbing pigment, aluminum or other metals) deposited on the membrane 150. Such a layer may be applied in a vapor deposition, screen printing or other thin-film process. Alternatively, the shielding material (e.g., carbon or metal nanoparticles) may be mixed with precursors that form the membrane 150 such that the electromagnetic shielding material is incorporated in the structure of the membrane. Combinations of these approaches may be used as well.

Having the membrane 150 disposed across the acoustic path of the microphone assembly 100 has potential to affect the performance of the microphone assembly 100 due to unequal pressure acting on either side of the membrane 150. For example, the membrane 150 may diminish the signal to noise ratio (SNR) due to a change in the boundary conditions of the membrane 150 (e.g., change in compliance). SNR loss tends to increase with decreasing compliance and vice versa. The compliance of the membrane 150 may be characterized relative to the compliance of other parts of the microphone assembly 100. The compliance of acoustic devices is a known characteristic and may be readily determined (e.g., empirically or by modeling) by those of ordinary skill in the art. For example, apart from the membrane 150, the compliance of the microphone assembly 100 generally includes compliance associated with the internal volume of the microphone assembly 100 and any compliance associated with the transducer (e.g., a condenser diaphragm 112), among other possible constituents depending on the type of device. In various embodiments, the compliance of the microphone assembly 100 may include the compliance of the membrane 150, the compliance of the diaphragm 112 and the internal volume of the microphone assembly 100.

Generally, the membrane 150 has a compliance that is 10 to 100 times the compliance of the diaphragm 112 at 1 atm pressure and room temperature. These ranges are not intended to be limiting and the compliance of a particular membrane for a particular acoustic device will depend on the type, application requirements and performance specification among other factors associated with the acoustic device. The compliance of the membrane 150 is based on air pressure acting on the membrane 150 or a temperature of the membrane 150. However, variations in atmospheric pressure acting on the membrane 150 as well as variations in ambient temperature may cause changes in the compliance of the membrane 150, as well as changes in the compliance of the diaphragm 112 and the internal volume of the microphone assembly 100 (e.g., expansion or contraction of the internal volume).

Pressure equalization or relief may be performed in some acoustic devices to accommodate changes in pressure that may result from changes in atmospheric pressure and elevation changes and particularly rapid pressure changes that may occur in elevators, aircraft, etc., or large ambient temperature changes. Providing a small vent through the membrane 150 may provide pressure relief by equalizing pressure on opposite sides of the membrane 150, for example, between the internal volume of the microphone assembly 100 and the exterior thereof. However, the vent allows an ingress path for contaminants and moisture. In other embodiments, pressure relief may be associated with a gas diffusion property of the membrane 150. The diffusion rate depends generally on the area and thickness of the membrane 150, among other factors. The diffusion rate of the membrane, however, may limit the ability of the membrane to accommodate some pressure gradients to which the acoustic device is exposed.

The integrated circuit 120 is configured to overcome this challenge by providing in-situ calibration of the response of the acoustic transducer 110 to account for a range of boundary conditions of the membrane (e.g., for a range of compliance of the membrane 150), for example, due to changes in atmospheric pressure and temperature. Specifically, the integrated circuit 120 is configured to determine a correlation between an electrostatic response and an acoustic response of the acoustic transducer 110, for a range of boundary conditions of the membrane 150 (e.g., the compliance of the membrane 150, and optionally also the compliance of the diaphragm 112 and the internal volume of the microphone assembly 100). The correlation is then used to adjust an acoustic signal measured by the microphone assembly 100 based on the specific boundary condition of the membrane 150 (e.g., compliance of the membrane 150 at an operating atmospheric pressure and/or temperature) under which the microphone assembly 100 is operating.

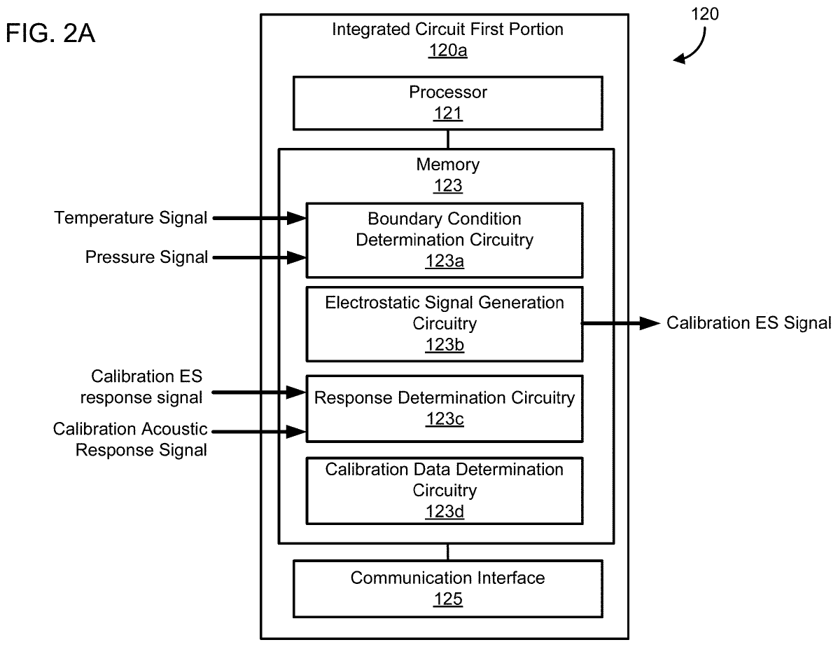

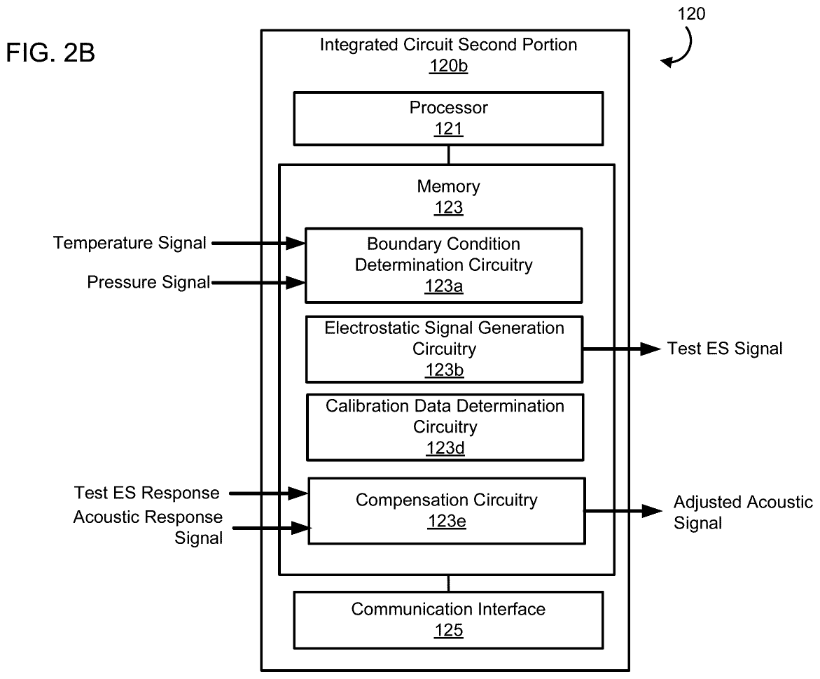

FIG. 2A is a schematic block diagram of an integrated circuit first portion 120a, and FIG. 2B is a schematic block diagram of an integrated circuit second portion 120b of the integrated circuit 120, according to a particular embodiment. The integrated circuit first portion 120a is configured to determine calibration data for a range of boundary conditions of the membrane 150, and the integrated circuit second portion 120b is configured to calibrate the microphone assembly 100 based on a corresponding boundary condition of the membrane 150.

In some embodiments, the range of boundary conditions may include a range of compliance of the membrane 150. For example, the compliance of the membrane 150 changes with respect to an atmospheric pressure and temperature acting on the membrane 150, which is a physical property of the membrane 150. Therefore, based on the environmental temperature and air pressure to which the microphone assembly 100, and thereby the membrane 150 is exposed to, a corresponding compliance of the membrane 150 can be determined (e.g., theoretically or based on experimentally determined data). Thus, a range of compliance of the membrane 150 based on a range of air pressure and temperatures acting on the membrane 150 can be determined, with the range of compliance of the membrane 150 defining the range of boundary conditions. It is to be appreciated that changes in air pressure and temperature may also impact the compliance of the diaphragm 112 and the internal volume of the microphone assembly 100, which also impacts the overall compliance of the microphone assembly 100, albeit at a much smaller scale relative to the compliance of the membrane 120.

Thus, in some embodiments, the range of boundary conditions may include a range of total compliance of the microphone assembly 100 over a corresponding range of temperatures and air pressures, i.e., the range of compliance of the membrane 150 as well as a range of compliance of the diaphragm 112 and a range of internal volume of the microphone assembly 100. Again, the range of boundary conditions (e.g., the range of compliance of the membrane 150 and optionally, range of compliance of the diaphragm 112 and/or range of internal volume of the microphone assembly 100) for a temperature or pressure range (e.g., a range of temperatures and pressures that the microphone assembly 100 is expected to be exposed to) may be predetermined before calibrations, and stored in a memory 123 of the microphone assembly 100, such as a memory external to or included in the integrated circuit 120 (e.g., as an equation, an algorithm or a lookup table). Based on a temperature or pressure that the microphone assembly 100 is exposed to, the corresponding boundary condition (e.g., the compliance of the membrane 150 or overall compliance of the microphone assembly 100) can be determined by the integrated circuit 120.

The integrated circuit 120 may include one or more components, for example, a processor 121, a memory 123, and/or a communication interface 125. The processor 121 may be implemented as one or more general-purpose processors, an application specific integrated circuit (ASIC), one or more field programmable gate arrays (FPGAs), a digital signal processor (DSP), a group of processing components, or other suitable electronic processing components. In other embodiments, the DSP may be separate from the integrated circuit 120 and in some implementations, may be stacked on the integrated circuit 120. In some embodiments, the one or more processors 121 may be shared by multiple circuits and may execute instructions stored, or otherwise accessed, via different areas of memory). Alternatively or additionally, the one or more processors 121 may be structured to perform or otherwise execute certain operations independent of one or more co-processors. In other example embodiments, two or more processors 121 may be coupled via a bus to enable independent, parallel, pipelined, or multi-threaded instruction execution. All such variations are intended to fall within the scope of the present disclosure. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

In some embodiments, the integrated circuit 120 may include a memory 123. The memory (e.g., RAM, ROM, Flash Memory, hard disk storage, etc.) may store data and/or computer code which may be executable by the processor 121 included in the integrated circuit 120. The memory 123 may be or include tangible, non-transient volatile memory or non-volatile memory. Accordingly, the memory 123 may include database components, object code components, script components, or any other type of information structure for supporting the various activities and information structures of the microphone assembly 100. In various embodiments, the integrated circuit 120 may also include one or more signal amplification circuitry (e.g., transistors, resistors, capacitors, operational amplifiers, etc.) or noise reduction circuitry (e.g., low pass filters, high pass filters, band pass filters, etc.). In other embodiments, the integrated circuit 120 may include analog-to-digital conversion circuitry configured to convert an analog electrical signal from the acoustic transducer 110 into a digital signal. The communication interface 125 may include wired and/or wireless interfaces (e.g., jacks, antennas, transmitters, receivers, communication interfaces, wire terminals, etc.) for conducting data communications with the acoustic transducer 110 and external devices (e.g., a central controller of a host device including the microphone assembly 100).

The integrated circuit first portion 120a may include boundary condition determination circuitry 123a, electrostatic signal generation circuitry 123b, response determination circuitry 123c and calibration data determination circuitry 123d. The various circuitries may be embedded as hardware configured to communicate with the one or more processors 121, algorithms or instructions stored in the memory 123 that are executable by the one or more processors 121, or a combination thereof.

The integrated circuit first portion 120a is configured to determine calibration data correlating an electrostatic response to an acoustic response of the acoustic transducer 110 for a range of boundary conditions of the membrane 150. Such calibration data may be determined in a controlled environment, for example, in a factory where the microphone assembly 100 is manufactured. For example, a lookup table correlating a range of temperatures and pressures to a range of boundary conditions (e.g., a range compliance of the membrane 150 or overall compliance of the microphone assembly 100) may be stored in the boundary condition determination circuitry 123a. The boundary condition determination circuitry 123a is configured to receive and interpret a temperature signal and pressure signal (e.g., from a temperature or pressure sensor provided in the microphone assembly 100 or included in a host device that includes the microphone assembly 100) to determine a temperature and pressure acting on the microphone assembly 100, and determine the corresponding boundary condition using the lookup table. Thus, the microphone assembly 100 may be exposed to a range of temperatures and pressures, and the corresponding range of boundary conditions may be determined by the boundary condition determination circuitry 123a. For example, the range of boundary conditions may include a range of compliance of the membrane 150 recorded as an absolute value, or a ratio indicating the order of magnitude that the compliance of the membrane 150 is smaller or greater than the compliance of the diaphragm 112 (e.g., 0.1× compliance relative to the diaphragm 112 up to 10× compliance relative to the diaphragm 112, or any other suitable range).

The electrostatic signal generation circuitry 123b is configured to drive the acoustic transducer 110 using a calibration electrostatic signal. The calibration acoustic signal may include a frequency sweep, for example, between a range of 0 and 100 kHz, which causes the membrane 150 to displace and produce sound. In some embodiments, the calibration electrostatic signal may include a pure tone electrostatic signal.

The response determination circuitry 123c is configured to receive a calibration electrostatic response signal responsive to the calibration electrostatic signal for the range of the boundary conditions of the membrane 150 and measure a calibration electrostatic response of the acoustic transducer 110 therefrom. The range of boundary conditions may include a range of compliance of the membrane 150, as previously described herein. In some embodiments, the calibration electrostatic response includes an acoustic sensitivity signal received from the acoustic transducer 110. In other embodiments, the calibration electrostatic response includes a location of a resonance peak and/or low frequency resonant oscillation of the acoustic transducer 110.

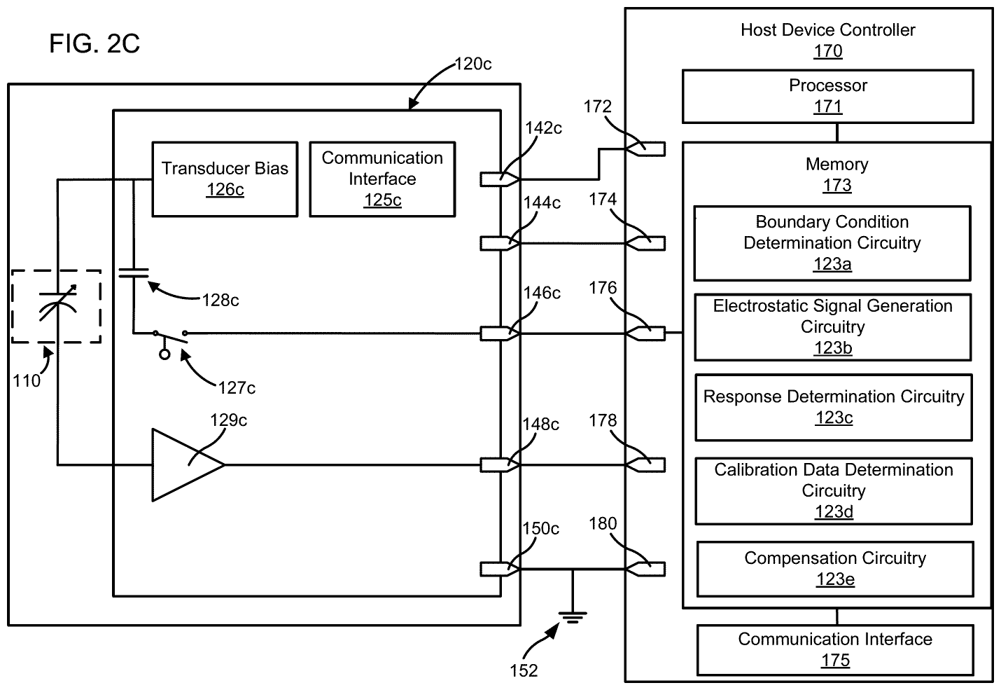

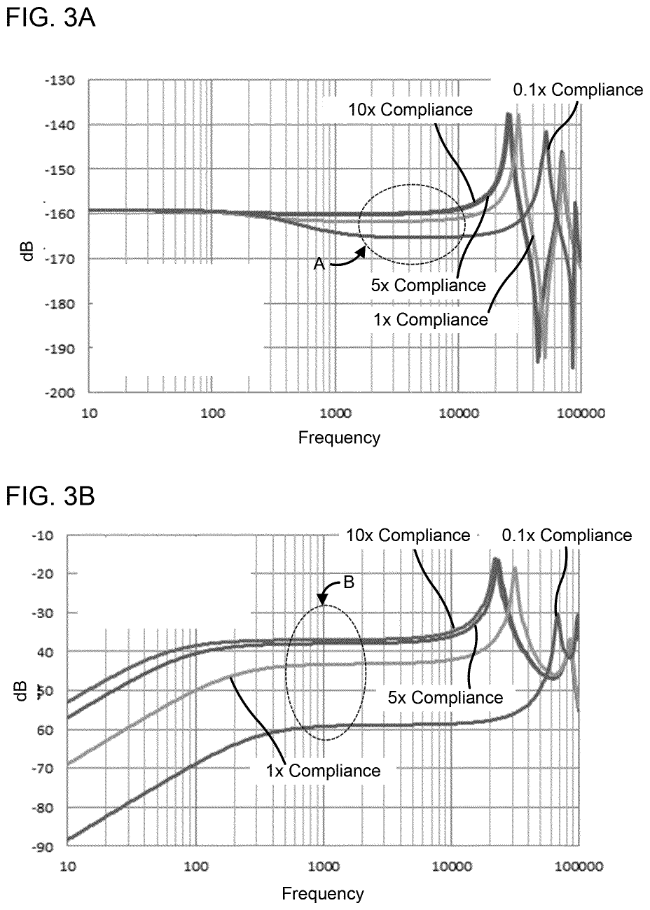

For example, FIG. 3A shows plots of a calibration electrostatic response of a MEMS transducer in response to a calibration electrostatic signal for various compliances of a membrane that is disposed across a port of a microphone assembly that includes the MEMS transducer. The portion of the plots indicated by the arrow A in FIG. 3A indicates the frequencies of interest. The membrane compliance was set at 10×, 5×, 1× and 0.1× of the compliance of the diaphragm of the acoustic transducer. A 10× compliance is the default value and smaller compliance indicates that the membrane is stiffened due to pressure difference across the membrane. Reduction in compliance below 5× leads to a lower sensitivity, as indicated by a lower acoustic signal generated by the acoustic transducer due to smaller displacement of the diaphragm thereof.

Referring again to FIG. 2A, the response determination circuitry 123c is also configured to receive a calibration acoustic response signal responsive to a calibration acoustic signal for the range of the boundary conditions of the membrane 150 (e.g., a range of compliance of the membrane 150) and measure a calibration acoustic response of the acoustic transducer 110 therefrom. For example, the microphone assembly 100 may be exposed to the calibration acoustic signal that includes an acoustic frequency signal swept between the same frequency range as the calibration electrostatic signal (e.g., the range of 0-100 kHz) and for the same range of boundary conditions (e.g., a range of compliance of the membrane as described with respect to FIG. 3A) as those used for determining the calibration electrostatic response. In some embodiments, the calibration acoustic response includes an acoustic sensitivity signal received from the acoustic transducer 110 in response to the calibration acoustic signal. In other embodiments, the calibration acoustic response includes a location of a resonance peak and/or low frequency resonant oscillation of the acoustic transducer 110. It is to be appreciated that the calibration acoustic response includes the same measurement parameter (e.g., acoustic sensitivity or resonance peak location) as the calibration electrostatic response.

For example, FIG. 3B shows plots of a calibration acoustic response of the MEMS transducer of FIG. 3A in response to a calibration acoustic signal for various compliances of the membrane. The portion of the plots indicated by the arrow B in FIG. 3B correspond to the same frequency as the portion A of FIG. 3A. The membrane compliance was set at 10×, 5×, 1× and 0.1× of compliance of the diaphragm of the acoustic transducer. Reduction in compliance below 5× leads to a lower sensitivity, as indicated by lower frequency response measured by the acoustic transducer due to smaller displacement of the diaphragm thereof, similar to the calibration electrostatic response.

Referring again to FIG. 2A, a calibration electrostatic response of the acoustic transducer 110 can be used as a proxy for the anticipated acoustic response of the acoustic transducer 110 under the same boundary conditions of the membrane 150. The calibration data determination circuitry 123c is configured to determine calibration data correlating the calibration electrostatic response to the calibration acoustic response for the range of boundary conditions, and stores the calibration data in a memory of the microphone assembly 100 (e.g., the memory 123) as stored calibration data. The stored calibration data may include an algorithm or an equation correlating the calibration electrostatic response to the calibration acoustic response. In some embodiments, the stored calibration data can include multiple calibration parameters, each of the multiple calibration parameters correlating the calibration electrostatic response to the corresponding calibration acoustic response, for example, in the form of a lookup table, for the range of boundary conditions. For example, for each boundary condition tested, for example, compliance of the membrane 150 determined by the boundary condition determination circuitry 123a corresponding to a particular air pressure and/or temperature measured using a pressure and temperature sensor (e.g., included in the microphone assembly 100 or external thereto), the stored calibration data may include a calibration electrostatic response for that specific boundary condition and a corresponding calibration acoustic response for the same boundary condition.

Referring to FIG. 2B, the integrated circuit second portion 120b is configured to account for changes in boundary conditions of the membrane 150 (e.g., due to changes in ambient pressure and temperature) and adjust acoustic response of the acoustic transducer 110 accordingly. The integrated circuit second portion 120b includes the boundary condition determination circuitry 123a, the electrostatic signal generation circuitry 123b, the calibration data determination circuitry 123d and a compensation circuitry 123e.

The boundary condition determination circuitry 123a receives a temperature and pressure signal, for example, from a temperature and pressure sensor included in the microphone assembly 100 or external thereto (e.g., included in a system such as cell phone, laptop, headphones, TV/set-top box remote, etc.), and determines the corresponding boundary condition, for example, a compliance of the membrane 150 or overall compliance of the microphone assembly 100 at the respective temperature and pressure, as previously described herein.

The electrostatic signal generation circuitry 123b drives the MEMS transducer using a test electrostatic signal. The test electrostatic signal may include a pure tone electrostatic signal. In various embodiments, the test electrostatic signal may include a frequency sweep in the audible range (e.g., 2 Hz to 20 kHz). In various implementations, this adjustment process may be performed periodically, in response to certain sensed conditions, or in any other manner.

The compensation circuitry 123e is configured to receive a test electrostatic response signal and measure a test electrostatic response of the acoustic transducer 110 therefrom. The test electrostatic response may be stored in a memory of the integrated circuit 120 (e.g., the memory 123). The compensation circuitry 123e determines a difference between the test electrostatic response and the calibration electrostatic response for a corresponding boundary condition of the membrane 150, for example, the compliance of the membrane 150 as determined by the boundary condition determination circuitry 123a based on the respective temperature and/or pressure acting on the microphone assembly 100.

The integrated circuit second portion 120b is configured to adjust the acoustic response of the acoustic transducer 110 using the calibration parameter in response to the test electrostatic response being different from the calibration electrostatic response for a corresponding boundary condition. For example, if the difference is zero or within a predetermined range (within +1 dB) no further action is taken. In contrast, if the difference is non-zero or is outside the predetermined range, the compensation circuitry 123e determines a calibration parameter using stored calibration data received from the calibration data determination circuitry 123d, which correlates calibration electrostatic responses with calibration acoustic responses of the acoustic transducer 110 across a range of boundary conditions of the membrane 150 based on the difference. Determining the calibration parameter includes selecting a parameter from the stored calibration data.

The compensation circuitry 123e is also configured to receive an acoustic response signal corresponding to a frequency and magnitude of an acoustic signal impinging on the membrane 150, and determine the acoustic response therefrom. The compensation circuitry 123e adjusts the acoustic response of the acoustic transducer 110 using the calibration parameter. For example, the calibration parameter may include a numerical number (e.g., a dB value) which is added to the acoustic response to account for signal loss due to decrease in compliance of the membrane 150, or a multiplication factor (e.g., a gain factor) which may be multiplied with the acoustic response to determine the adjusted acoustic response. The in-situ compensation may be performed at any suitable frequency, for example, every 5 minutes, 10 minutes, 20 minutes, 30 minutes, 1 hour or at any other suitable frequency. In some implementations, the in-situ compensation may not be performed at regular intervals; for example, in some implementations, the compensation may be performed in response to the occurrence of certain predetermined conditions (e.g., a sudden change in pressure or temperature acting on the microphone assembly, turning ON of a system including the microphone assembly 100, etc.).

It should be appreciated that while the various operations described herein are described as being performed by the integrated circuit 120, in other implementations, such operations may be performed by a controller or processing device external to the microphone assembly 100. For example, the microphone assembly 100 or any other microphone assembly described herein may be included in a host device (e.g., a cellphone, hand held device, wearable, TV/set top box remote, headphones, etc.) and a host device controller of the host device may be configured to perform at least some of the operations described with respect to the integrated circuit 120.

For example, FIG. 2C is a schematic block diagram of an integrated circuit 120c that may be used in the microphone assembly 100 or any other microphone assembly described herein, and a host device controller 170 (hereon “the controller 170”) coupled to the integrated circuit 120c, according to an embodiment. The controller 170 may be coupled to the integrated circuit 120c through communication leads provided in the base 102 (e.g., a printed circuit board). The controller 170 includes a processor, a memory 173 and a communication interface 175. Unlike the integrated circuit 120, the boundary condition determination circuitry 123a, the electrostatic signal generation circuitry 123b, the response determination circuitry 123c, the calibration data determination circuitry 123d and the compensation circuitry 123e are included in the controller 170 and may be similar in structure and function as described herein previously with respect to the controller 120. However, the controller 170 is also configured to perform other operations for controlling the host device, in some implementations.

The integrated circuit 120c includes a communication interface 125c configured to communicate with the acoustic transducer 110 and the controller 170. The communication interface 125c may be substantially similar to the communication interface 125, as previously described herein. The integrated circuit 120c also includes a transducer bias circuitry 126c configured to provide a bias voltage to the acoustic transducer 110. The integrated circuit 120c also includes an operational amplifier 129c configured to filter and/or amplify a signal (e.g., a current, voltage or differential voltage) generated by the acoustic transducer 110 responsive to an acoustic signal.

The controller 170 includes a controller communication pin 172 communicably coupled to an integrated circuit communication pin 142c so as to provide communication between the communication interface 175 and 125c. A controller VDD pin 174 is communicably coupled to an integrated circuit VDD pin 144c and configured to provide a positive voltage to the integrated circuit 120c or serve as voltage drain therefor. The controller 170 also includes a controller input pin 178 communicably coupled to an integrated circuit output pin 148c. The controller input pin 178 is configured to receive an output signal from the acoustic transducer 110 via the integrated circuit 120c. The output signal may be filtered and/or amplified by the operational amplifier 129c before being transmitted to the controller 170. In various embodiments, the output signal includes the calibration ES response signal, the calibration acoustic response signal, the test ES response signal and/or the acoustic response signal. Furthermore, the controller 170 and the integrated circuit 120c include a controller ground pin 180 and an integrated circuit ground pin 150c, respectively, each of which is coupled to an electrical ground 152.

The controller 170 also includes a controller ES signal pin 176 communicably coupled to an integrated circuit ES signal pin 146c and configured to communicate the calibration ES signal and/or the test ES signal to the acoustic transducer 110 via the integrated circuit 120c. In some embodiments, the integrated circuit 120c also includes a switch 127c and a capacitor 128c disposed between the electrical lead (e.g., a solid state electrical lead) electrically coupling the integrated circuit ES signal pin 146c to the acoustic transducer 110. The switch 127c is moveable between an open position and closed position to allow selective communication of the test electrostatic signal or the calibration electrostatic signal from the host device controller 170 to the acoustic transducer 110. The integrated circuit 120c may be configured to selectively close the switch 127c to allow the calibration ES signal and/or the test ES signal to be communicated to the acoustic transducer 110 so as to allow calibration of the acoustic transducer 110 and adjusting acoustic response of the acoustic transducer 110, as previously described herein.

In some embodiments, a microphone assembly (e.g., the microphone assembly 100) including the integrated circuit 120c may be calibrated at a manufacturers site before being installed in a host device. The calibration data may be stored in a memory of the microphone assembly (e.g., the microphone assembly 100) including the integrated circuit 120c, or in other implementations, a memory included in the integrated circuit 120c (e.g., the memory 123). In such embodiments, the integrated circuit 120c is configured to drive the acoustic transducer 110 using a test electrostatic signal received from the controller 170. The integrated circuit 120c transmits a test electrostatic response signal received from the acoustic transducer 110 to the controller 170, the test electrostatic response signal corresponding to a test electrostatic response of the acoustic transducer 110, as previously described herein. The integrated circuit 120c retrieves stored calibration data from the memory of the microphone assembly (e.g., included in the integrated circuit 120c or separate therefrom) and communicate the stored calibration data to the controller 170 so as to allow the controller 170 to determine a calibration parameter therefrom. In some implementations, the integrated circuit 120c may transmit the calibration data the first time the controller 170 communicates with the integrated circuit 120c (e.g., the host device is first turned ON), and the calibration data may then onwards be stored on the memory 173 of the controller 170. In other implementations, the calibration data is transmitted after a test electrostatic signal is transmitted to the acoustic transducer 110 from the controller 170 via the integrated circuit 120c.

In particular embodiments, the stored calibration data correlates calibration electrostatic responses with calibration acoustic responses of the acoustic transducer 110 across a range of boundary conditions of the membrane 150. In such embodiments, the calibration parameter is based on: (a) a difference between the test electrostatic response and a calibration electrostatic response for a corresponding boundary condition of the membrane 150, and (b) the calibration data, as previously described herein. The integrated circuit 120c communicates an acoustic response signal corresponding to an acoustic response of the acoustic transducer 110 to the controller 170. The controller 170 adjusts the acoustic response of the acoustic transducer 110 using the calibration parameter, for example, to account for change in compliance of the membrane 150, as previously described herein.

While the embodiment shown in FIG. 2C represents an embodiment in which most or all of the functionality is implemented within the controller 170, it should be appreciated that, in some implementations, portions of the functionality may be distributed between the controller 170 and the integrated circuit 120c. For example, in some implementations, parameters and/or instructions for performing the tests/calibration may be stored in the integrated circuit 120c and may be used/implemented by the integrated circuit 120c, but a portion of the instructions for initiating and/or conducting the tests/calibration may be implemented in the controller 170 and communicated to the integrated circuit 120c from the controller 170. All such implementations and modifications are contemplated within the scope of the present disclosure.

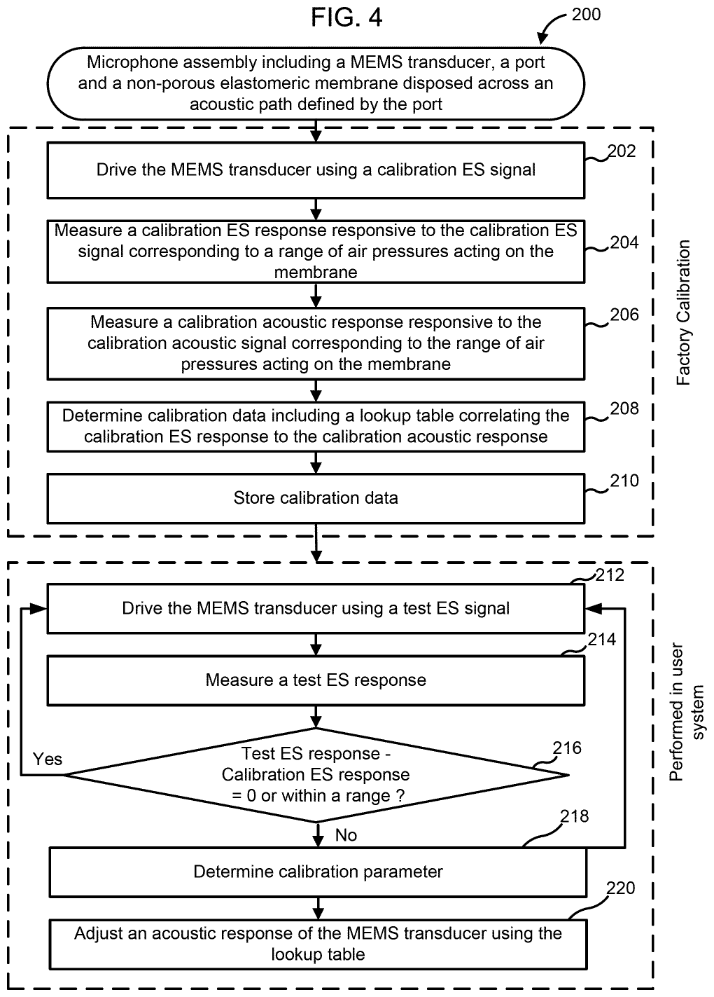

FIG. 4 is a schematic flow diagram of a method 200 for calibrating a microphone assembly or any other acoustic assembly that includes a non-porous elastomeric membrane disposed across a port of the acoustic assembly, according to an embodiment. The microphone assembly (e.g., the microphone assembly 100) includes a MEMS transducer (e.g., the acoustic transducer 110) disposed in an internal volume of the microphone assembly (e.g., the internal volume defined between the base 102 and the cover 130), a port (e.g., the port 104 provided in the base 102) providing an acoustic path from the acoustic transducer 110 to the external atmosphere, and a non-porous elastomeric membrane (e.g., the membrane 150) disposed across the port and structured to seal the microphone assembly. In some embodiments, an integrated circuit (e.g., the integrated circuit 120) included in the microphone assembly may be configured to perform the operations of the method 200. In other embodiments, a system controller of a system including the microphone assembly may be configured to perform the operations of the method 200.

The method 200 includes driving the MEMS transducer using a calibration electrostatic signal, at 202. For example, the electrostatic signal generation circuitry 123b generates a calibration electrostatic signal (e.g., a pure tone electrostatic signal) configured to drive the acoustic transducer 110 which causes the diaphragm 112 to displace. At 204, a calibration electrostatic response of the MEMS transducer responsive to the calibration electrostatic signal corresponding to a range of boundary conditions of the membrane is measured. For example, the microphone assembly 100 may be exposed to a range of temperatures and/or pressures, and the boundary condition determination circuitry 123a determines the range of boundary conditions (e.g., compliance of the membrane 150 or overall compliance of the microphone assembly 100) corresponding to the range of temperatures and/or pressures. The electrostatic response of the acoustic transducer 110 in response to the range of boundary conditions of the membrane 150 is measured by the response determination circuitry 123c.

In some embodiments, the boundary condition may also include a compliance of the diaphragm 112 and the internal volume of the microphone assembly 100. For example, changes in air pressure and/or temperature may also impact the compliance of the diaphragm 112 and the air present in the front volume 105 and/or back volume 131 does affecting the overall compliance of the microphone assembly 100. Thus, the range of boundary conditions is a range of compliance of the microphone assembly 100 based collectively on the compliance of the membrane 150, the compliance of the diaphragm 112 and the internal volume of the microphone assembly 100, for a corresponding range of air pressures and/or temperature under which the microphone assembly 100 is operating.

At 206, a calibration acoustic response of the MEMS transducer is measured responsive to a calibration acoustic signal for the range of boundary conditions. For example, the microphone assembly 100 is exposed to a calibration acoustic signal having the same frequency range as the calibration electrostatic signal, and the calibration acoustic response of the acoustic transducer 110 is determined by the response determination circuitry 123b for the range of the boundary conditions, as previously described herein. In various embodiments, the calibration electrostatic response and the calibration acoustic response include an acoustic sensitivity, location of a resonance peak and/or low frequency resonant oscillation of the MEMS transducer.

At 208, calibration data correlating the calibration electrostatic response to the calibration acoustic response for the range of boundary conditions is determined. For example, the calibration data determination circuitry 123c determines the calibration data. At 210, the calibration data is stored in a memory of the acoustic transducer as stored calibration data. For example, the calibration data determination circuitry 123c stores the calibration data as stored calibration data in the memory 123 of the integrated circuit 120. The stored calibration data may include an algorithm or an equation. In some embodiments, the stored calibration data includes multiple calibration parameters, each of the multiple calibration parameters correlating the calibration electrostatic response to the corresponding calibration acoustic response for a boundary condition in the range of boundary conditions. For example, the stored calibration data may include a lookup table. Operations 202 to 210 may be performed in a factory or an assembly plant where the microphone assembly 100 is assembled.

At 212, the MEMS transducer is driven using a test electrostatic signal. For example, the electrostatic signal generation circuitry 123a generates the test electrostatic signal which drives the acoustic transducer 110. The test electrostatic signal may include a pure tone electrostatic signal.

At 214, a test electrostatic response of the MEMS transducer is measured. At 216, a difference between the test electrostatic response and the calibration electrostatic response for a corresponding boundary condition of the membrane is determined. For example, the corresponding boundary condition (e.g., the corresponding compliance of the membrane 150) is determined by the boundary condition determination circuitry 123a based on the pressure and/or temperature that the microphone assembly 100 is exposed to. The compensation circuitry 123e receives the test electrostatic response and determines the difference. If the difference is zero or within a predetermined range (e.g., ±1 dB) for a corresponding boundary condition, no further action is taken and the method 200 returns to operation 212.

However, if the difference is not equal to zero or is otherwise greater than the predetermined range at the corresponding boundary condition, a calibration parameter is determined using stored calibration data based on the difference, at 218. The calibration data correlates calibration electrostatic responses with calibration acoustic responses of the MEMS transducer across a range of boundary conditions of the membrane. For example, the compensation circuitry 123e determines the calibration parameter from the calibration data stored in the memory 123 of the acoustic transducer 110. In some embodiments, determining the calibration parameter includes selecting a parameter from the stored calibration data (e.g., a lookup table).

At 220, an acoustic response of the MEMS transducer is adjusted using the calibration parameter. For example, the compensation circuitry 123d adjusts the acoustic response of the acoustic transducer 110 using the calibration parameter, therefore adjusting for signal loss, for example, due a reduction in compliance of the membrane 150 because of changing air pressure and/or temperature.

In some embodiments, a method comprises driving a microelectromechanical systems (MEMS) transducer of a microphone assembly using a test electrostatic signal. The microphone assembly comprises a substrate, a cover, a port providing an acoustic path between an exterior of the microphone assembly and the MEMS transducer, and a non-porous elastomeric membrane disposed across the port and structured to seal the microphone assembly. A test electrostatic response of the MEMS transducer is measured, and a difference between the test electrostatic response and a calibration electrostatic response for a corresponding boundary condition of the membrane is determined. A calibration parameter is determined using stored calibration data based on the difference. The calibration data correlates calibration electrostatic responses with calibration acoustic responses of the MEMS transducer across a range of boundary conditions of the membrane. An acoustic response of the MEMS transducer is adjusted using the calibration parameter.

In some embodiments, a microphone assembly comprises a substrate and a cover. A microelectromechanical systems (MEMS) transducer is disposed in an internal volume of the microphone assembly defined between the substrate and the cover and configured to generate an electrical signal responsive to an acoustic signal. A port is provided in the microphone assembly and provides an acoustic path between an exterior of the housing and the MEMS transducer. A non-porous elastomeric membrane is disposed across the port and structured to seal the microphone assembly. An integrated circuit is disposed in the internal volume and electrically coupled to an electrical output of the transducer. The integrated circuit is configured to drive the MEMS transducer using a test electrostatic signal, and measure a test electrostatic response of the MEMS transducer. The integrated circuit is configured to determine a difference between the test electrostatic response and a calibration electrostatic response for a corresponding boundary condition of the membrane. The integrated circuit is configured to determine a calibration parameter using stored calibration data based on the difference, the calibration data correlating calibration electrostatic responses with calibration acoustic responses of the MEMS transducer across a range of boundary conditions of the membrane, and adjust an acoustic response of the MEMS transducer using the calibration parameter.

In some embodiments, a microphone assembly comprises a substrate and a cover. A MEMS transducer is disposed within an internal volume of the microphone assembly defined between the substrate and the cover. The MEMS transducer is configured to generate an electrical signal responsive to an acoustic signal. A port provides an acoustic path from the MEMS transducer to an external atmosphere. A non-porous elastomeric membrane is disposed across the port and structured to seal the microphone assembly. An integrated circuit is disposed within the internal volume, the integrated circuit electrically coupled to an electrical output of the transducer and configured to be electrically coupled to a host device controller. The integrated circuit is configured to drive the MEMS transducer using a test electrostatic signal received from the host device controller; transmit a test electrostatic response signal received from the MEMS transducer to the host device controller, the test electrostatic response signal corresponding to a test electrostatic response of the acoustic transducer; retrieve stored calibration data from a memory of the microphone assembly and communicate the stored calibration data to the host device controller so as to allow the host device controller to determine a calibration parameter therefrom; and communicate an acoustic response signal corresponding to an acoustic response of the MEMS transducer to the host controller device, the host controller device adjusting the acoustic response of the MEMS transducer using the calibration parameter.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method, comprising:
driving a microelectromechanical systems (MEMS) transducer of a microphone assembly using a test electrostatic signal, the microphone assembly comprising a substrate and a cover, a port providing an acoustic path from the MEMS transducer to an external atmosphere, and a non-porous elastomeric membrane disposed across the port and structured to seal the microphone assembly;
measuring a test electrostatic response of the MEMS transducer;
determining a difference between the test electrostatic response and a calibration electrostatic response for a corresponding boundary condition of the membrane;
determining a calibration parameter using stored calibration data based on the difference, the calibration data correlating calibration electrostatic responses with calibration acoustic responses of the MEMS transducer across a range of boundary conditions of the membrane; and
adjusting an acoustic response of the MEMS transducer using the calibration parameter.

2. The method of claim 1, further comprising:
prior to driving the MEMS transducer using the test electrostatic signal, driving the MEMS transducer using a calibration electrostatic signal;
measuring the calibration electrostatic response of the MEMS transducer responsive to the calibration electrostatic signal corresponding to the range of boundary conditions;
measuring the calibration acoustic response of the MEMS transducer responsive to a calibration acoustic signal for the range of boundary conditions;
determining calibration data correlating the calibration electrostatic response to the calibration acoustic response for the range of boundary conditions; and
storing the calibration data in a memory of the microphone assembly as the stored calibration data.

3. The method of claim 2, wherein the calibration electrostatic signal and the test electrostatic signal comprise a pure tone electrostatic signal.

4. The method of claim 2, wherein the calibration electrostatic response and the calibration acoustic response comprise at least one of an acoustic sensitivity, location of a resonance peak or low frequency resonant oscillation of the MEMS transducer.

5. The method of claim 2, wherein the stored calibration data includes multiple calibration parameters, each of the multiple calibration parameters correlating the calibration electrostatic response to the corresponding calibration acoustic response for a boundary condition in the range of boundary conditions, wherein determining the calibration parameter comprises selecting a parameter from the stored calibration data.

6. The method of claim 1, wherein the acoustic response of the MEMS transducer is adjusted using the calibration parameter in response to the test electrostatic response being different from the calibration electrostatic response for a corresponding boundary condition.

7. The method of claim 1, wherein the boundary condition comprises a compliance of the membrane.

8. The method of claim 1, wherein the MEMS transducer includes a back plate and a diaphragm separating an internal volume of the microphone assembly into a front volume and a back volume, and wherein the boundary condition comprises a compliance of the microphone assembly, the compliance of the microphone assembly based on a compliance of the membrane, a compliance of the diaphragm and the internal volume of the microphone assembly.

9. A microphone assembly, comprising:
a substrate;
a cover;
a microelectromechanical systems (MEMS) transducer disposed within an internal volume of the microphone assembly defined between the substrate and the cover, the MEMS transducer configured to generate an electrical signal responsive to an acoustic signal;
a port providing an acoustic path from the MEMS transducer to an external atmosphere;
a non-porous elastomeric membrane disposed across the port and structured to seal the microphone assembly; and
an integrated circuit disposed within the internal volume and electrically coupled to an electrical output of the transducer, the integrated circuit configured to:
drive the MEMS transducer using a test electrostatic signal;
measure a test electrostatic response of the MEMS transducer;
determine a difference between the test electrostatic response and a calibration electrostatic response for a corresponding boundary condition of the membrane;
determine a calibration parameter using stored calibration data based on the difference, the calibration data correlating calibration electrostatic responses with calibration acoustic responses of the MEMS transducer across a range of boundary conditions of the membrane; and
adjust an acoustic response of the MEMS transducer using the calibration parameter.

10. The microphone assembly of claim 9, wherein the integrated circuit is further configured to:
drive the MEMS transducer using a calibration electrostatic signal;
measure the calibration electrostatic response of the MEMS transducer responsive to the calibration electrostatic signal corresponding to the range of the boundary conditions;
measure the calibration acoustic response of the MEMS transducer responsive to a calibration acoustic signal for the range of the boundary conditions of the membrane;
determine calibration data correlating the calibration electrostatic response to the calibration acoustic response for the range of boundary conditions; and
store the calibration data in a memory of the microphone assembly as the stored calibration data.

11. The microphone assembly of claim 10, wherein the calibration electrostatic signal and the test electrostatic signal comprise a pure tone electrostatic signal.

12. The microphone assembly of claim 9, wherein the stored calibration data comprises an algorithm.

13. The microphone assembly of claim 12, wherein the stored calibration data includes multiple calibration parameters, each of the multiple calibration parameters correlating the calibration electrostatic response to the corresponding calibration acoustic response for the range of boundary conditions, wherein determining the calibration parameter comprises selecting a parameter from the stored calibration data.

14. The microphone assembly of claim 9, wherein the integrated circuit is configured to adjust the acoustic response of the MEMS transducer using the calibration parameter in response to the test electrostatic response being different from the calibration electrostatic response for a corresponding boundary condition.

15. The microphone assembly of claim 9, wherein the boundary condition comprises a compliance of the membrane.

16. The microphone assembly of claim 9, wherein the MEMS transducer includes a back plate and a diaphragm separating the internal volume of the microphone assembly into a front volume and a back volume, and wherein the boundary condition comprises a compliance of the microphone assembly, the compliance of the microphone assembly based on a compliance of the membrane, a compliance of the diaphragm and the internal volume of the microphone assembly.

17. The microphone assembly of claim 9, wherein the calibration electrostatic response and the calibration acoustic response comprise at least one of an acoustic sensitivity, location of a resonance peak or low frequency resonant oscillation of the MEMS transducer.

18. A microphone assembly, comprising:
a substrate;
a cover;
a microelectromechanical systems (MEMS) transducer disposed within an internal volume of the microphone assembly defined between the substrate and the cover, the MEMS transducer configured to generate an electrical signal responsive to an acoustic signal;
a port providing an acoustic path from the MEMS transducer to an external atmosphere;
a non-porous elastomeric membrane disposed across the port and structured to seal the microphone assembly; and
an integrated circuit disposed within the internal volume, the integrated circuit electrically coupled to an electrical output of the transducer and configured to be electrically coupled to a host device controller, the integrated circuit configured to:
drive the MEMS transducer using a test electrostatic signal received from the host device controller;
transmit a test electrostatic response signal received from the MEMS transducer to the host device controller, the test electrostatic response signal corresponding to a test electrostatic response of the acoustic transducer;
retrieve stored calibration data from a memory of the microphone assembly and communicate the stored calibration data to the host device controller so as to allow the host device controller to determine a calibration parameter therefrom; and
communicate an acoustic response signal corresponding to an acoustic response of the MEMS transducer to the host controller device, the host device controller configured to adjust the acoustic response of the MEMS transducer using the calibration parameter.

19. The microphone assembly of claim 18, wherein the stored calibration data correlates calibration electrostatic responses with calibration acoustic responses of the MEMS transducer across a range of boundary conditions of the membrane, and wherein the calibration parameter is based on: (a) a difference between the test electrostatic response and a calibration electrostatic response for a corresponding boundary condition of the membrane, and (b) the calibration data.

20. The microphone assembly of claim 18, wherein the integrated circuit comprises a switch movable between an open position and a closed position so as to allow selective communication of the test electrostatic signal from the host device controller to the MEMS transducer.
